(19) United States
(12) Patent Application Publication
(10) Pub. No.: US 2012/0014266 A1
(43) Pub. Date: Jan. 19, 2012

(54) MANAGING A CONVERGED DEVICE THAT IS CAPABLE OF COMMUNICATING WITH A PLURALITY OF CONNECTIONS

(76) Inventors: Osvaldo Diaz, San Mateo, CA (US); Mamoun Abu-Samaha, San Jose, CA (US)

(21) Appl. No.: 12/866,773

(22) PCT Filed: Oct. 31, 2008
(86) PCT No.: PCT/US2008/081931

§ 371 Date: Aug. 9, 2010

Related U.S. Application Data
(60) Provisional application No. 61/028,291, filed on Feb. 13, 2008.
(60) Provisional application No. 61/028,319, filed on Feb. 13, 2008.
(60) Provisional application No. 61/028,313, filed on Feb. 13, 2008.

(51) Int. Cl. H04L 12/28; H04L 12/26

(52) U.S. Cl. 370/252; 370/255

(57) ABSTRACT

Various embodiments pertain to managing a converged electronic device 110 that is capable of communicating with a plurality of connections 132, 134. According to one embodiment, a first configuration associated with the converged electronic device 110 is used 220 while the converged electronic device 110 communicates using a first connection 132. An event that relates to the converged electronic device 110 is detected 230 that indicates a second connection 134 could provide a higher level of service for the converged electronic device 110. A second configuration that would be used for the converged electronic device 110 is determined 240 while the converged electronic device 110 communicates using the second connection 134. The second configuration is used 250 while the converged electronic device 110 communicates using the second connection 134.

### RELATED APPLICATIONS

This patent application claims priority to and benefit of the co-pending U.S. Provisional Patent Application No. 61/028,291 which has an Attorney Docket Number 200801137-1, and is entitled “Converged Device Management for Service Continuity” by Osvaldo Diaz at al., filed on Feb. 13, 2008.

This patent application claims priority to and benefit of the co-pending U.S. Provisional Patent Application Number: 61/028,319 which has an Attorney Docket Number 200801140-1, and is entitled “Remote Management with Translation Between OMA-DM and WSMAN” by Osvaldo Diaz et al., filed on Feb. 13, 2008.

This patent application claims priority to and benefit of the co-pending U.S. Provisional Patent Application No. 61/028,313 which has an Attorney Docket Number 200801143-1, and is entitled “Hosted Management Server Supporting Multiple Management Frameworks” by Osvaldo Diaz at, filed on Feb. 13, 2008.

This application is related to U.S. patent application Ser. No. ______ by Osvaldo Diaz et al., filed on the same date as the present application and entitled “Providing Manageability to an Electronic Device That Supports Location Limited Manageability Functionality” with attorney docket no HP 200801140-2, assigned to the assignee of the present application.

This application is related to U.S. patent application Ser. No. ______ by Osvaldo Diaz et al., filed on the same date as the present application and entitled “Managing Electronic Devices with Different Types of Device Location Limited Device Management Clients” with attorney docket no. HP 200801143-2, assigned to the assignee of the present application.

### BACKGROUND

As electronic devices become more common, people are demanding electronic devices that have more capabilities. For example, people want their cell phones to not only be able to make phone calls but also to be able to take pictures and to be able to provide movie viewing capabilities. As a part of providing more capabilities, devices that can communicate over more than one type of connection are being manufactured. Devices that use more than one toe of connection are referred to as “converged devices.” An example of a converged device is a cell phone that can communicate over either a 3 GPP (3^{rd} Generation Partnership Project) network or a Wi Fi (Wireless Fidelity) network.

### BRIEF DESCRIPTION OF THE DRAWINGS

The accompanying drawings, which are incorporated in and form a part of this specification, illustrate embodiments of the invention and, together with the description, serve to explain the principles of embodiments of the invention:

FIG. 1 is a block diagram of a system for managing a converged electronic device, according to one embodiment.

FIG. 2 is a flowchart of a method for managing a converged electronic device, according to one embodiment.

FIG. 3 is a block diagram of a system for translating functions between a location agnostic device management entity and a location limited entity, according to one embodiment.

FIG. 4 is a block diagram of a system for translating functions between a location agnostic entity and a location limited entity, according to another embodiment.

FIG. 5 depicts a block diagram of one example of a type of computer that can be used in accordance with or to implement various embodiments which are discussed herein.

The drawings referred to in this description are not draw to scale except if specifically noted.

### DESCRIPTION

Reference will now be made in detail to various embodiments of the invention, examples of which are illustrated in the accompanying drawings. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined, by the appended claims. Furthermore, in the following description of various embodiments of the present invention, numerous specific details are set forth in order to provide a thorough understanding of the present invention. In other instances, well-known methods, procedures, components, and circuits have not been described in detail so as not to unnecessarily obscure aspects of the present invention.

Devices that use more than one type of connection are referred to as “converged devices.” An example of a converged device is a cell phone that can communicate over either a 3 GPP (3^{rd} Generation Partnership Project) network or a Wi Fi (Wireless Fidelity) network. There are special problems involved in managing converged devices. For example, a 3 GPP network and a Wi Fi network provide different levels of service, such as different baud rates, which may cost different amounts to use. The 3 GPP network may provide a higher baud rate than a Wi Fi network but may also cost more. Assume for this illustration that the 3 GPP network provides a baud rate of 30 frames per second (fps) and the Wi Fi network provides 20 fps. Assume that a user has a converged device that is a cell phone that can communicate over either a 3 GPP network or a Wi Fi network. The user is watching a movie over the 3 GPP network on his cell phone while outside of the user's home. After the user comes to his home, which has a router with Wi Fi capabilities, the user continues to watch the movie on his cell phone. Since the user is at home, the Wi Fi network could be used to deliver the movie. If the 3 GPP network continues to be used to deliver the movie even though the Wi Fi network is available, the user will pay more than if the movie were delivered on the Wi Fi network.

According to one embodiment, one configuration is used while a converged device is communicating using one connection. Continuing the example, the configuration that pertains to a 3 GPP network would indicate that the 3 GPP network can provide 30 fps. The configuration that a converged device is using can be communicated to the service provider of the movie. The service provider uses the configuration to determine what level of service the current connection can provide. Examples of levels of service include but are not limited to baud rate and the amounts that a service costs. Continuing the example, the service provider communicates the movie at 30 fps in accordance with the configuration that relates to the 3 GPP network. When an event is detected that indicates that a higher level of service could be provided by a new connection, the configuration that pertains to the new connection is determined. Continuing the example, the fact that the user has moved within range of the Wi Fi network is an example of an event that is detected. The Wi Fi network can provide the movie at a lower cost, which for this example is considered to be a higher level of service. The configuration that pertains to the new connection is determined. The new configuration is used while the converged electronic device communicates using the new configuration. Continuing the example, a new configuration that indicates that the Wi Fi network can communicate the movie at 20 fps is determined. The new configuration may be transmitted to the service provider of the movie as a part of adjusting the service delivery of the movie. For example, the new configuration that indicates the Wi Fi network can communicate the movie at 20 fps is transmitted to the service provider of the movie. The service provider then uses the new configuration to adjust the service delivery of the movie to the cell phone.

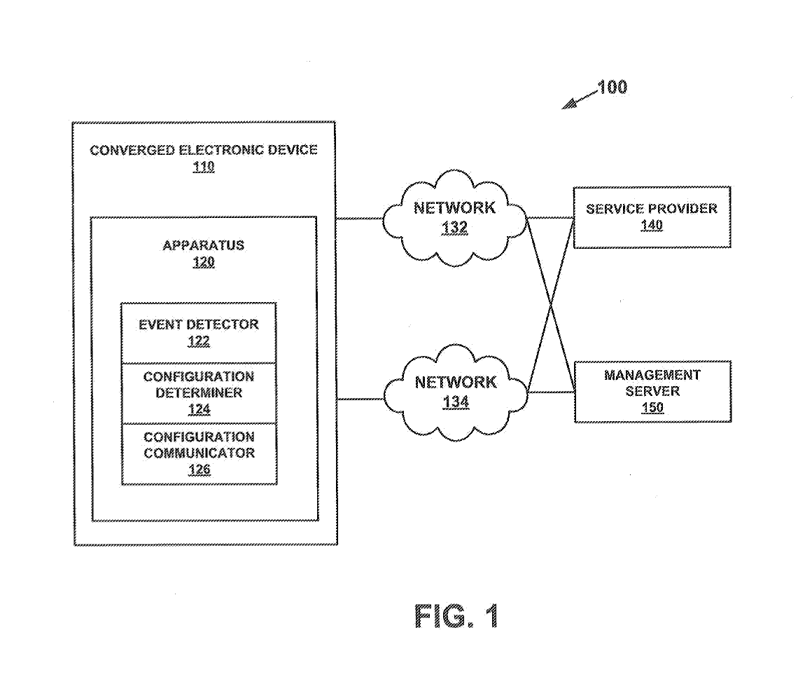

FIG. 1 is a block diagram of a system for managing a converged electronic device, according to one embodiment. The blocks that represent features in FIG. 1 can be arranged differently than as illustrated, and can implement additional or fewer features than what are described herein. Further, the features represented by the blocks in FIG. 1 can be combined in various ways. The system 100 can be implemented using software, hardware, firmware, or a combination thereof.

The system 100 depicts a converged electronic device 110, a service provider 140, a management server 150 and two networks 132, 134. The converged electronic device 110 includes an apparatus 120 for managing the converged electronic device 110. The converged electronic device 110, the service provider 140 and the management server 150 are capable of communicating over either of the networks 132, 134

The apparatus 120 includes a managing-a-converged-electronic-device-using-configurations-to-adjust-service delivery-event-detector 122 (also referred to herein as an “event detector”), a managing-a-converged-electronic-device-using-configurations-to-adjust-service delivery-configuration-determiner 124 (also referred to herein as a “configuration determiner”), and a managing-a-converged-electronic-devioe-using-configurations-to-adjust-service delivery-configuration-communicator 126 (also referred to herein as a “configuration communicator”). The event detector 122 is configured for detecting an event that relates to the converged electronic device 110 that indicates a connection could provide a higher level of service, such as delivering media a different baud rate or for a different cost, than what is currently being provided for the converged electronic device 110. The configuration determiner 124 is configured for determining which configuration would be used for the converged electronic device 110 while the converged electronic device 110 communicates using the connection. The configuration communicator 126 is configured for communicating the determined configuration to a service provider 140 to provide the level of service that the connection is capable of.

According to various embodiments, converged electronic devices 110 are managed. A converged electronic device 110 may be a mobile device such as a cell phone, a laptop, or a personal digital assistant (PDA), among other things. A converged electronic device 110 may be a device that is used in a home (also referred to herein as a “home device”), such as a router, a gateway, a modem, a kitchen appliance, a television, a set-top-box, a computer, a printer, an in-home femtocell base station, a gaming device, which may be connected to a network or another electronic device, and a laptop, among other things. A converged electronic device 110 may be a device that is used for work (also referred to herein as a “work device”), such as a router, a modem, a gateway, a computer, a laptop, a phone, a PDA, and a printer, among other things. Work devices may be associated with a company or an enterprise that traditionally provides information technology or does not provide information technology. A company may be a small, medium or large-sized company. A converged electronic device 110 may be a computer based device, such as a desk top computer, a laptop, or a server device, among other things. A converged electronic device 110 may be a client device or a server device.

A converged electronic device 110, according to one embodiment, provides more than one type of connection. For example, a converged electronic device 110 may be a cell phone that can communicate over a 3 GPP network or a Wi Fi network. In another example, a converged electronic device 110 may be a cell phone that can communicate over a 3 GPP network and a Wi Max (Wireless Fidelity Maximum) network. In another example, a converged electronic device 110 may be a laptop that is capable of communicating with a service provider, such as T-Mobile™, using 802.11 Wi Fi and 2.5/3 G cellular communications.

A converged electronic device 110 can be used for providing any type of service to a user. A service is typically delivered in the form of media to a converged electronic device 110. According to various embodiments, media can be usual media that is seen, audio media that is heard, or audio visual media that is seen and heard. For example, the media can be music that is listened to, can be a web page that is read, or can be a video that is listened to and watched. The media can be rich media Rich media is a term that shall be used to refer to videos, high definition data, or high quality data among other things.

A service provider 140 is any provider that is capable of providing a service, such as providing media. For example, a service provider 140 may provide music, movies, web pages that provide information, such as stock quotes, web pages that enable a user to interact with yet other services such as web pages that enable a user to sell or buy stocks, among other things.

Examples of service providers 140 include, but are not limited to, Apple ITunes™, ATT wireless™, Google Picasa™, Hewlett Packard™™ Snapfish™, and Verizon™.

A converged electronic device 110, according to one embodiment, provides more than one type of connection. A connection may be a network 132, 134 or a bearer. Examples of networks 132, 134 are 3 GPP networks, Wi Fi networks, Wi Max networks, switched networks, and so on. A bearer is a connection type. For example, T-Mobile™ provides a couple of bearers in the form of 802.11 Wi Fi and 2.5/3 G cellular communications.

Connections can provide different levels of service. For example, a 3 GPP connection and a Wi Fi connection can provide media at different baud rates and also cost different amounts.

According to one embodiment, a configuration pertains to a type of connection. A configuration can be used to communicate a level of service, such as a baud rate or the cost for delivering media, that a network or bearer is capable of providing. An event, according to one embodiment, indicates that a new connection has become available to the converged electronic device 110.

According to one embodiment, configurations can be used as a part of adjusting delivery of a service to a level that can be provided given the capabilities of the converged electronic device 110, the capabilities of a connection used by the converged electronic device 110 and so on. The configuration used by a converged electronic device 110 and a service provider 140 may be changed, for example, when the converged electronic device 110 is going to use a different network or a different bearer.

A configuration may contain various types of information that can be used, for example, as a part of adjusting the delivery of a service to a converged electronic device 110. For example a configuration may contain any one or more of information about the converged electronic device 110's capabilities, information about a connection, the service consumption characteristics of a network or bearer, and quality of service (QoS). Examples of capabilities of a connection include minimum bandwidth and recommended bandwidth, among other things. QoS, information associated with a configuration may include, the minimum QoS or a recommended QoS.

A converged electronic device 110 may have been configured with pertinent configurations when the converged electronic device 110 was manufactured, configured by the company that sold the converged electronic device, or the converged electronic device 110 may obtain configurations, for example, from a management server 150, as will become more evident.

Different connections, that result from different networks 132, 134 or different bearers, can provide services at different levels. According to one embodiment, a new configuration is used when that new configuration can provide a higher level of service.

According to one embodiment, policies are used for determining whether a new connection can provide a higher level of service. For example, a user may specify in a policy that they always want to switch from a switching network to a Wi Fi network if a Wi Fi network becomes available in order to take advantage of the cost savings provided by Wi Fi. In another example, the user may specify in a policy that they would like to switch from a switching network to a Wi Fi network if the Wi Fi network is capable of providing a certain bandwidth specified by the user.

Policies may be specified by users. However, default policies may also be provided, for example, by a management server 150, as will become more evident. Default policies may also be installed on a converged electronic device 110, for example, by the manufacturer of the converged electronic device 110 or installed by the company that sells the converged electronic device 110, among other things. According to one embodiment, a user may use a default policy as a basis for creating a user specified policy. For example, a user may create a user specified policy by modifying a few criteria associated with a base policy.

A higher level of service may be determined without a policy. For example, when a new connection becomes available, the converged device 110 may display a message asking the user whether they would like to switch to the new connection. The user can determine whether the new connection would provide them with a higher level of service and respond to the message accordingly. According to one embodiment, a user specified policy and a user responding to a message to determine whether a new connection will be used are both examples of a user determining whether a new connection provides a higher level of service.

Recommendations may be provided to the user when determining whether a new connection provides a higher level of service. The recommendations may be used as a part of the user responding to displayed messages or as a part of the user creating a user specified policy. The user may be provided recommendations in the form of displayed messages or provided as a part of a user interface, among other things. The recommendations may reside at the converged electronic device 110 or may reside outside of the converged electronic device 110, for example, at a management server 150 or a web site.

A management platform defines a standard that software, which is also referred to herein as an “entity,” can be developed around, according to one embodiment. One entity is typically a managing entity that manages another entity (also referred to as “a managed entity”) and by extension manages the device that a managed entity resides on. For example, referring to FIG. 1, management server 150 is an example of a managing entity and converged electronic device 110 is an example of a managed entity. Entities that conform to related management platforms can communicate with each other with a corresponding management protocol (also referred to herein as a “device management protocol”). Although many of the embodiments are described in terms of entities that are software, entities that conform to management platforms may also be implemented using hardware or firmware, or a combination of any two or more of software, hardware, or firmware.

Examples of management platforms that have corresponding management protocols are Open Mobile Alliance Device Management (OMA-DM), Web Services Management (WSMAN), Simple Network Management Protocol (SNMP), Technical Requirement-069 (TR-D69), and TR-111. The entities typically use a communication protocol, such as TCP-IP, to transmit information that conforms to the respective management protocol to enable a managing entity to manage a managed entity. As will become more evident, management platforms and their respective management protocols can be either location agnostic or location limited.

Location agnostic device management pertains to managing devices 110 regardless of where the devices 110 are located. A location agnostic protocol is a management protocol that can be used for communicating between a management server 150 and devices 110 regardless of where the devices 110 are located. The location agnostic protocol, according to one embodiment, is a hypertext transfer protocol (HTTP) extensible markup language (XML) based protocol that can be used, for example, by phones. The location agnostic protocol may enable part of the communications to be transmitted over the internet and may use short message service (SMS), for example, to initiate communications. A location agnostic protocol can be used, for example, to communicate via one or more cell phone towers and the Internet. An example of a location agnostic protocol is the Open Mobile Alliance-Device Management (OMA-DM) protocol.

Since a location agnostic protocol can be used to communicate via one or more cell phone towers and the internet, a location agnostic protocol can be used to communicate with electronic devices 110 regardless of where they are located. For example, a location agnostic protocol can be used to communicate with an electronic device 110 even when that electronic device moves. In another example, a location agnostic protocol can be used to communicate with an electronic device 110 that is behind a NAT, behind a firewall, or behind a gateway.

A location agnostic entity may be a client, for example that resides on converged electronic device 110, or a server 150, among other things, that conforms to a location agnostic management platform, such as OMA-DM. A minimal interface, such as what is commonly known as a “proxy client,” may be used to provide a location agnostic client on the converged electronic device 110, among other places, for the purposes of managing the converged electronic device 110 regardless of where it is located.

Electronic devices 110 that are associated with a trusted environment may have location limited device management associated with them. Location limited device management pertains to managing devices 110 but restricts where those devices are located. That is, location limited device management can only be used to manage devices 110 while the devices 110 are in a particular physical or electronic (network) location. For example, the devices 110 may be restricted to a network associated with an enterprise or a home. A location limited protocol is a management protocol that is used for communicating with location limited clients on electronic devices 110 while those devices 110 are associated with a particular area or a particular network. Examples of location limited protocols are Web Services Management (WSMAN)™, Simple Network Management Protocol (SNMP), Technique Requirement-069 (TR-069), and TR-111.

Many electronic devices are traditionally configured to communicate using location limited protocols. For example, many computer based devices are configured to use the WSMAN protocol. In another example, many chip sets are configured to use the WSMAN protocol. In yet another example, many televisions are configured to use TR-111. In still another example, many routers and modems are configured to use TR-069.

A location limited entity may be a client or a server 150, among other things, which conforms to a location limited platform, such as WSMAN, SNMP, TR-069, or TR-111. A location limited entity may reside on an electronic device 110 that is, for example, a mobile device, a television, a computer based device, or a router, among other things.

According to one embodiment, a management server 150 provides configurations to converged electronic devices 110. For example, a converged electronic device 110 may store configurations that relate to the connections associated with the converged electronic device 110. If the converged electronic device 110 is capable of 3 GPP and Wi Fi the converged electronic device 110 may include configurations for 3 GPP and Wi Fi if the converged electronic device 110 does not have a configuration that pertains to the connections associated with it, the converged electronic device 110, according to one embodiment, obtains the pertinent configuration from a management server 150. A converged electronic device 110 may obtain a configuration from a management server 150 in the event that the converged electronic device 110 never had the configuration or in the event that a configuration that resides on the converged electronic device 110 has become corrupted, among other things.

According to one embodiment, the management server 150 is a location agnostic server. In this case, a cell phone that is a converged electronic device 110 can obtain a configuration from the management server 150 regardless of where the cell phone 110 is located, as will become more evident.

According to one embodiment, the management server 150 communicates with location agnostic clients that are associated with the converged electronic devices 110. The location agnostic clients that are associated with the converged electronic devices 110 may be light weight. For example, the location agnostic clients may only implement the set of commands that are used for obtaining configurations.

A management server 150 may provide default policies to converged electronic devices 110 that are used as a part of determining whether a new connection may provide a higher level of service. For example, the management server 158 may communicate default policies to the converged management devices 110 that it manages.

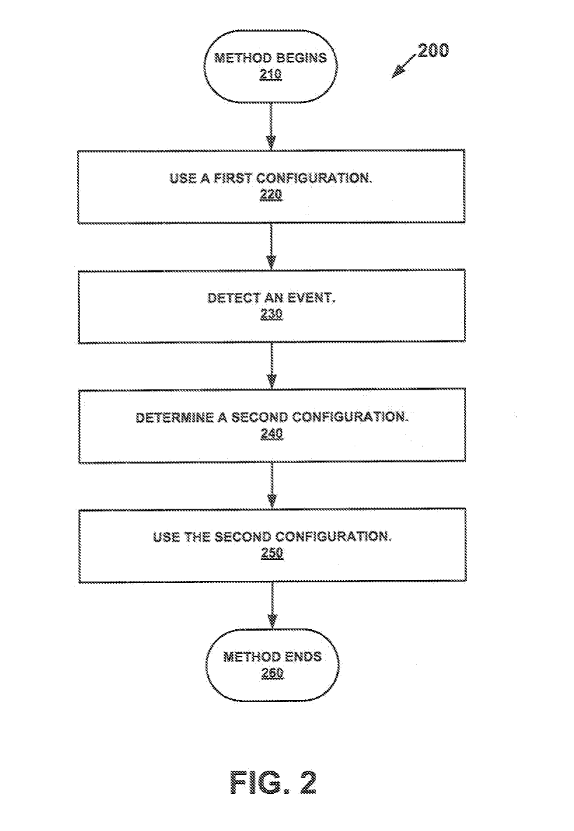

FIG. 2 is a flowchart of a method for managing a converged electronic device, according to one embodiment. Although specific steps are disclosed in flowchart 200, such steps are exemplary. That is, embodiments of the present invention are well suited to performing various other steps or variations of the steps recited in flowchart 200. It is appreciated that the steps in flowchart 200 may be performed in an order different than presented, and that not all of the steps in flowchart 200 may be performed.

The following illustration shall refer to FIGS. 1 and 2,

Assume that the converged electronic device 110 is a that is capable of communicating using 3 GPP network (cellular) or a Wi Fi network. Assume that network 132 is a 3 GPP network and network 134 is a Wi Fi network. Assume that the owner of the cell phone 110 has a router in their house that has Wi Fi capabilities. Initially the user is using their cell phone 110 outside of their house so the cell phone 110 communicates using the 3 GPP network 132. Assume that the 3 GPP network 132 is capable of 30 frames per second (fps) while the Wi Fi network 134 is capable of 20 fps.

When the user powers their cell phone 110 on while outside their house, the event detector 122 detects that the cell phone 110 was turned on and that the 3 GPP network 132 is available for use by the cell phone 110. The configuration determiner 124 locates a 3 GPP configuration that pertains to the 3 GPP network 132. The cell phone 110 is currently not obtaining a level of service and therefore the 3 GPP configuration is able to provide a higher level of service than what the cell phone 110 is currently obtaining. The configuration communicator 126 communicates the 3 GPP configuration to whatever service provider 140 the user is interested in obtaining a service from. For example, assume that the user is interested in watching a movie on their cell phone 110. In this case, the 3 GPP configuration is communicated to the movie service provider 140 and the movie service provider 140 provides the movie based on the 3 GPP configuration.

At 210, the method begins.

At 220, a first configuration is used. For example, in this illustration the 3 GPP configuration is a first configuration. The 3 GPP configuration specifies, for example, service consumption capabilities, among other things, that are appropriate for the 3 GPP network 132 being used. The 3 GPP configuration indicates that the 3 GPP network 132 is capable of providing 30 fps for the communication.

At 230, an event is detected. For example, the user enters their house where their Wi Fi capable router is located. The event detector 122 associated with the cell phone 110 detects that the Wi Fi network 134 can be reached using the Wi Fi capable router. According to one embodiment, various operating system (OS) calls can be used as a part of detecting that a new network or bearer has become available. The OS call or calls that are used depend on the OS. For example, in a personal computer (PC), there are standard OS calls that can be used as a part of detecting a new internet protocol (IP) address. In general OSs detect that a new network or bearer is available in the order of first a local area network (LAN) or cable, second a Wi Fi, and third 3 G.

A determination is made as to whether the Wi Fi network 134 could provide a higher level of service. For example, the cell phone 110 may display a message asking the user whether they want to switch to the Wi Fi network 134, in another example, a user specified policy may be used to determine whether the user specified that a Wi Fi network 134 would provide them with a higher level of service than a 3 GPP network. In another example, a default policy may be used for determining whether the Wi Fi network 134 would provide a higher level of service. Recommendations may be provided to the user. For example, the user may be provided recommendations in the form of displayed messages. The recommendations may reside at the converged electronic device 110 or may reside outside of the converged electronic device 110, for example, at a management server 150. In still another example, the OS may decide whether to switch from one carrier or bearer to a newly detected carrier or bearer.

Continuing the illustration, assume that the Wi Fi network 134 provides a higher level of service because the movie can be delivered to the cell phone 110 more cheaply using the Wi Fi network 134 than using the 3 GPP network 132.

At 240, a second configuration is determined. For example, the Wi Fi network 134 is capable of providing different service consumption capabilities, etc. . . . to the cell phone. The configuration determiner 124 associated with the cell phone 110, determines which configuration would be used to provide appropriate service consumption capabilities, etc. for the cell phone 110 while communicating over Wi Fi. If the appropriate configuration is not located on the cell phone 110, the apparatus 120 obtains the appropriate configuration from the management server 150. The appropriate configuration for a Wi Fi network 134 shall be referred to as a Wi Fi configuration and in this illustration is “the second configuration.”

At 250, the second configuration is used. For example, the configuration communicator 126 associated with the cell phone 110 communicates the Wi Fi configuration (e.g., “second configuration”) to the service provider 140. The second configuration indicates that the Wi Fi network 134 is capable of providing 20 fps. Therefore, the service provider 140 adjusts the delivery of the movie based on the second configuration from 30 fps to 20 fps.

At 260, the method ends.

The above illustration referred to switching configurations because a new connection became available. However, various embodiments can be used to switch configurations because the current connection can no longer be used. Continuing the example, assume that the user's router can no longer be used because it has encountered a problem. In this case, the two options are to either discontinue providing the movie or use the 3 GPP network 132 to provide the movie. According to one embodiment, using the 3 GPP network 132 to provide the movie provides a higher level of service than discontinuing the movie. The 3 GPP configuration, can be transmitted to the service provider 140 and the service provider 140 can use the 3 GPP configuration to adjust the delivery of the movie to 30 fps, among other things.

Many of the examples of various embodiments were in the context of a connection being a network 132, 134. However, various embodiments also pertain to the connection being a bearer. For example, Mobile™ has two types of bearers that they provide services over. Those two types of bearers are 802.11 Fi and 2.5/3 G. The capabilities over each connection type (or bearer) are dramatically different. If there is a change on a converged electronic device 110 such that, for example, Wi Fi were to go down, then according to various embodiments, the converged electronic device 110 and the T-Mobile™ service provider 140 could use a 2.5/3 G configuration. As a part of using the 2.5/3 G configuration, the T-Mobile™ service provider 140's network infrastructure could transcode a video stream to a smaller resolution prior to the switch over to the 2.5/3 G bearer.

Management can be provided to electronic devices by configuring the electronic devices and diagnosing problems associated with the electronic devices, among other things. An electronic device that uses a location limited client (“location limited” shall be used herein to refer to “device location limited management”) lose its management capabilities when the electronic device moves outside of an area that the electronic device is configured to use. A network that the electronic device is configured to use is an example of an area where the electronic device is provided manageability via the electronic device's location limited client communicating with a location limited server over the network.

Various embodiments pertain to providing manageability to an electronic device, which supports location limited manageability functionality, even when the electronic device moves outside of the area. For example, a location agnostic entity (“location agnostic” shall be used herein to refer to “device location agnostic device management”), which is capable of providing management regardless of where an electronic device is located, can be installed on the electronic device. The location agnostic entity and the location limited entity associated with the electronic device both provide a variety of functions. Function A provided by the location agnostic entity may provide similar management capabilities as function A′ associated with the location limited entity associated with the electronic device. Therefore, according to one embodiment, a mapping between a location agnostic entity's functions and the location limited entity's functions is used as a part of providing manageability even when the electronic device moves outside of an area as will become more evident.

Conventionally, electronic devices that are behind a network address translation table (NAT) cannot communicate with an entity that provides management, which is on the other side of the network address translation table (NAT). However, various embodiments enable electronic devices behind a NAT to be managed by communicating with the managing entity that is on the other side of a NAT. In another example, a conventional electronic device may be managed only while it is associated with a certain network. The electronic device may or may not be behind a firewall. However, various embodiments enable electronic devices to be managed when the electronic device leaves the network. Various embodiments can also be used for electronic devices that have never been a part of a traditional IT network, such as a cell phone. Various embodiments can be used for devices that cross between a traditional IT enterprise environment and non-traditional IT enterprise environment. Various embodiments can be used for devices for small or medium-sized businesses (SMBs) that do not have traditional IT support capabilities. Therefore, various embodiments are well suited to home devices, which may be behind a NAT or a firewall, or a combination thereof, or a work device, which may be behind a firewall, among other things.

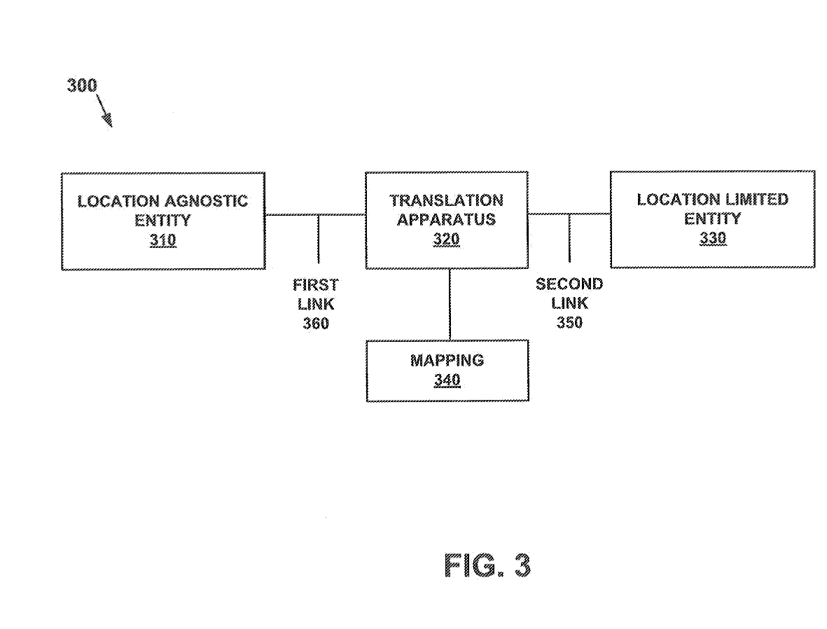

FIG. 3 is a block diagram of a system 300 for translating functions between a location agnostic device management entity (also known as “location agnostic entity”) and a location limited device management entity (also known as “location limited entity”), according to one embodiment. The blocks that represent features in FIG. 3 can be arranged differently than as illustrated, and can implement additional or fewer features than what are described herein. Further, the features represented by the blocks in FIG. 3 can be combined in various ways. The system 300 can be implemented using software, hardware, firmware, or a combination thereof.

The system 300 includes a location agnostic entity 310, a location limited entity 330, a mapping 340 between functions associated with the two entities 310 and 330, and a translation apparatus 320 for translating functions between the two entities 310 and 330.

The entities 310, 330 may be either clients or servers. Either the first link 360 or the second link 350, or both of the links 360, 350 may be a communications link over a network or may be a communications link that resides in an electronic device. The first link 360, or the second link 350 or both of the links 360, 350 may have Wi Fi capabilities.

The apparatus 320 can be co-located with the location agnostic entity 313. For example, the apparatus 320 and the location agnostic entity 310 may reside on the same server or on a network operations center (NOC), among other thins. The location agnostic entity 310 and the apparatus 320 may both be associated with a data center for an IT enterprise or reside with a web server.

The apparatus 320 may be co-located with the location limited entity 330. For example, the apparatus 320 and the location limited entity 330 may reside on an electronic client device.

The apparatus 320, the location agnostic entity 310, and the location limited entity 330 may all reside on the same electronic device, may be associated with the same company, or may be associated the same traditional IT enterprise. The electronic device may be a client device or a server device. The server device may be a we server.

The apparatus 320 may be located separately from both the location, agnostic entity 310 and the location limited entity 330. For example, the apparatus 320 may be located on an electronic device, such as a server device, that is separate from the electronic devices that the location agnostic entity 310 and the location limited entity 330 reside on. In one embodiment, the location agnostic entity 310, or the apparatus 320, or a combination thereof, reside on a web server. The mapping 340 may be co-located with the translation apparatus 320 or may be located separately from the translation apparatus 320.

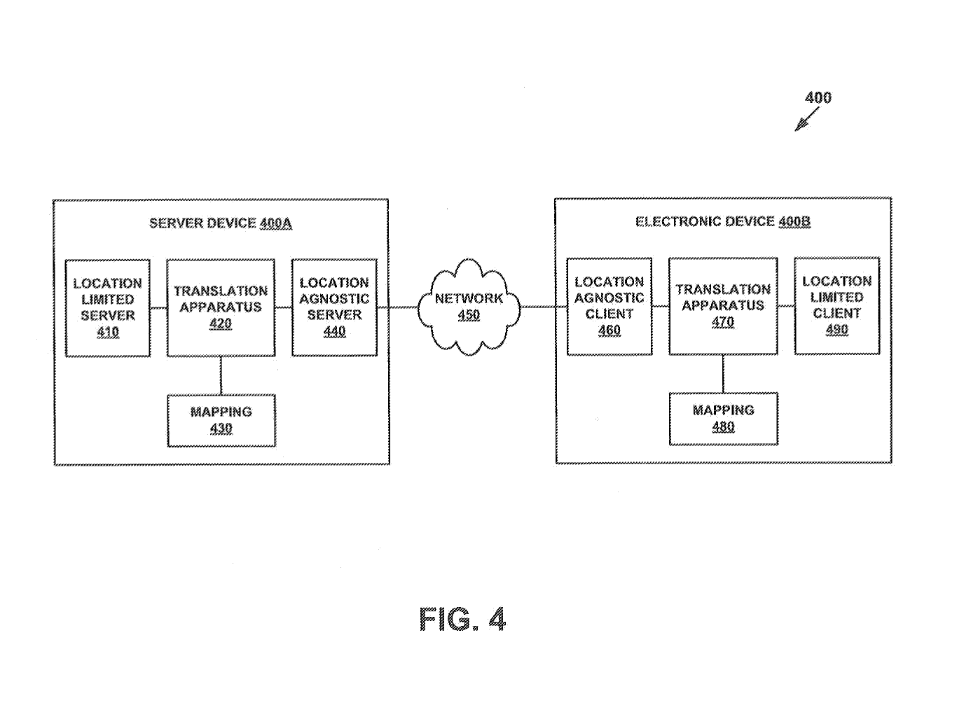

FIG. 4 is a block diagram of a system 400 for translating functions between a location agnostic entity and a location limited entity, according to another embodiment. The blocks that represent features in FIG. 4 can be arranged differently than as illustrated, and can implement additional or fewer features than what are described herein. Further, the features represented by the blocks in FIG. 4 can be combined in various ways. The system 400 can be implemented using software, hardware, firmware, or a combination thereof.

As depicted in FIG. 4, the translation can occur between two servers 410, 443 and between two chants 460, 490. For example, the first translation apparatus 420 and its corresponding mapping 430 can translate functions between a location limited server 410 and a location agnostic server 440. The second translation apparatus 470 and its corresponding mapping 480 can translate functions between a location agnostic client 460 and a location limited client 490.

The location limited server 410 and the location limited client 490 are examples of location limited entities 330. The location agnostic server 440 and the location agnostic client 460 are examples of location agnostic entities 310.

Although the server device 400A, as depicted in FIG. 4, includes the servers 410, 440, the translation apparatus 420, and the mapping 430, the server device 400A may include only one or may include more than one of the servers 410, 440, the first translation apparatus 420 or the first mapping 430. The server device 400A may be associated with a service provider. Any one or more of the servers 410, 440, the first translation apparatus 420, or the first mapping 430 can reside at among other things, a network operations center, an enterprise, or a server device 400A. The server device 400A may be a web server.

Although the client device 400B, as depicted in FIG. 4, includes the clients 460, 490, the translation apparatus 470 and the mapping 480, the client device 400B may include only one or may include more than one of the clients 460, 490 the second translation apparatus 470, and the second mapping 480. The electronic device 400B may be, among other things, a mobile device, an appliance, a router, a model, a television, or a computer.

Communications between various entities depicted in FIG. 4 may be performed over an Internet. For example, the network 450 may be the Internet. Communications between the location agnostic server 440 and the location agnostic client 460 depicted in FIG. 4 may be performed over a network 450 that includes Wireless Fidelity (Wi Fi) capabilities. Although network 450 is the only network depicted in FIG. 4, according to various embodiments, a network may be used to communicate between any of the components 410, 420, 430, 440, 460, 470, 480, 490 depicted in FIG. 4.

According to one embodiment, converged electronic devices 110 (FIG. 1) with different types of location limited chants can be managed in the context of either a system 300 or system 400. For example, the converged electronic device 110 (FIG. 1) may include any one or more of a location agnostic entity 310, translation apparatus 320, mapping 340, and location limited entity 330. According to one embodiment, the management server 150 (FIG. 1), may include any one or more of a location agnostic entity 310, translation apparatus 320, mapping 340, and location limited entity 330. According to one embodiment, converged electronic device 110 may be an electronic device 4003 and management server 150 may be a server device 400A.

Management can be provided to electronic devices by configuring the electronic devices and diagnosing problems associated with the electronic devices, among other things. For example, an electronic device can be managed by updating an application or diagnosing an error. In a second example, several electronic devices 400B, such as a television, a personal computer for work, and a laptop may all be connected to a router in a home. The router would use a NAT to provide connectivity for the three devices. The NAT would translate a single real IP address into three pseudo IP addresses for the three devices. Traditionally this has made it very difficult to manage devices 400B that are behind a NAT. Further, many of these devices 400B would have location limited functionality. However, according to various embodiments, a location agnostic protocol can be used to provide manageability to these devices 400B even though they are behind a NAT by communicating with cell phone towers and the Internet.

In another example, a person that works for company X may take their laptop 400B that is configured for company X′s network, that is behind a firewall X′, to another company Y that has a network behind firewall Y′. Traditionally, one or more firewalls, such as firewall X′ and Y′, would prevent the person from using their laptop 400B while inside of company Y. However, according to various embodiments, a location agnostic protocol and one or more translation apparatuses 320, 420, 470 and corresponding mappings 340, 430, 480 can enable the laptop 400B to communicate around the firewalls.

In yet another example, a person buys a laptop, a handset phone, or a mobile device from a company that sells electronic devices 400B. Assume that this company is not a traditional IT enterprise but is interested in providing manageability to the devices 400B that they sell. According to various embodiments, the electronic devices 400B they sell may have clients 460 and 490 and a second translation apparatus 470 as depicted in FIG. 4. The company may have servers 410 and 440 and a first translation apparatus 420 as depicted in FIG. 4 to provide the manageability to the electronic devices 400B that the company sells.

In still another example, assume that the electronic device 400B is lost and the user of the electronic device 400B calls up customer services or goes to a self care portal associated with a location agnostic server 440, such as an OMA-DM server, and requests that the hard disk on the electronic device 400B be reformatted or that the electronic device 400B be locked up. The location agnostic server 440 can communicate with the location agnostic client 460 on the electronic device 400B to reform that electronic device 400B's hard disk or to lock the electronic device 400B. Customer care may interact with a user interface associated with the location agnostic server 440 as a part of reformatting the electronic device 400B's hard disk or locking the electronic device 400B.

Other examples where various embodiments may be used include, but are not limited to, different phones with different protocols, different carriers, small or medium businesses that do not have traditional IT infrastructure, changing chip sets in a computer 400B where the original chip set and the new chip set use different protocols for providing manageability, a lost electronic device 400B, locking an electronic device 400B, reformatting hard disk on an electronic device 400B, shredding a hard disk on an electronic device 400B, recovering data, determining what OS was running on a device 400B, which has a crashed disk configuration.

Various embodiments provide a mapping 340, 430, 480 between a device location agnostic entity 310, 440, 460's functions and a device location limited entity 330, 410, 490's functions. According to one embodiment, the device location agnostic entity 310, 440, 460's functions are represented by OMA-DM objects (also known as “managed objects”). For example, a mapping 480 associated with an electronic client device 400B may map managed objects (MOs) device location limited functions, such as WSMAN functions.

The mapping 340, 430, 480 may map a subset of the functions associated with a device location limited entity 330, 410, 490 and a device location agnostic entity 310, 440, 460. The determination may be made by analyzing what functions are used most often or what functions would provide the greatest business opportunity.

in one embodiment, a translation app 320 and a corresponding mapping 340 may be implemented as a proxy client, which resides, for example, on a Network Operations Center (NOC) server. For example, assume that the location agnostic entity 310, such as an Open Mobile Alliance Device Management (OMA-DM) server, is associated with a service provider's server device, the translation apparatus 320 and corresponding mapping 340 are associated with a proxy client on the NOC server, and the location limited entity 330, such as a WSMAN client, is associated with a sees electronic device. Also assume that the user's electronic device includes a minimal location agnostic client, such as a minimal OMA-DM client. The NOC server with the associated proxy client and the location agnostic entity 310 may be associated with the same data center. The NOC server with the associated proxy client and the WSMAN location limited entity 330 may be associated with the same data center.

A help desk or a user self care web page may communicate with the location agnostic entity 310 which in turn communicates with the proxy client. The proxy client can use the translation apparatus 320 and the mapping 340 to determine a location agnostic function. A data structure representing the determined function can be communicated, using the OMA DM protocol, to the user's electronic device. The electronic device can use the minimal OMA-DM client to extract the data structure and communicate the pertinent information to the location limited entity 330.

As stated in the above example, the electronic client can use a minimal; location agnostic client, such as a minimal OMA-DM client. For example, if a location agnostic management platform and corresponding protocol provide interfaces for functions A, B and C but function A will suffice, the minimal location agnostic client may support function A but not support functions B and C.

According to one embodiment, the OMA DM protocol is used to communicate, for example, over the second link 350 as depicted in FIG. 3 or to communicate, for example, over the network 450 as depicted in FIG. 4. According to one embodiment, the OMA DM protocol is modified so that electronic devices that include a location limited entity 330 or a location limited client 490, among other things, are always connected and therefore Short Message Services (SMSs) are not required.

According to one embodiment, what is commonly known as “push technology” is used as a part of various client or server entities communicating. For example, “push technology” may be used to communicate between a translation apparatus 320 and a location agnostic entity 310 or between a translation apparatus 320 and a location limited entity 330. In another example, “push technology” may be used to provide communications between a location agnostic server 440 and a location agnostic client 460 or vice versa.

“HTTP server push” is one subcategory of “push technology.” According to one embodiment, HTTP server push is used as a part of communicating, for example, between a server 400A and a client 400. HTTP server push typically involves a server 400A pushing information to a client 400B. In situations where, a client 400B is pushing information to a server 400A, the client 400B may employ a push technology that is similar to HTTP server push.

According to one embodiment a converged electronic device 110 may initially include a location limited client 490 (FIG. 4) but not include a location agnostic client 460 (FIG. 4). According to one embodiment, the location agnostic client 460 can be installed on the converged electronic device 110, as will become more evident. Various embodiments described herein can also be used to install a translation apparatus 470 and a corresponding mapping 480 in addition to installing the location agnostic client 460 on the converged electronic device 110, as will become more evident.

For example, since there are many different types of electronic devices 110 (FIG. 1), 400B (FIG. 4) with many different types of communications protocols and management platforms as well as electronic devices that lack management platforms, there is a need for a method and a system to communicate and manage these disparate electronic devices, for example, with one management model. Further, there is a need for managing these disparate electronic devices from a single user interface.

Assume for the sake of illustration, assume that electronic device 110 (FIG. 1) is a server 440A (FIG. 4) that is a multi-management capable server and that electronic devices B and C are different types of electronic devices 4006 that the multi-management capable server 400A communicates with. An apparatus, which receives the device capabilities of the various electronic devices B and C, can be associated with the server 400A. The apparatus uses the devices B's and C's device capabilities to determine management protocol each of the electronic devices B and C use. The determined management protocols are used to install a location agnostic client onto the electronic devices B and C. For example, if the electronic device B's device capabilities indicate that electronic device B uses the Web Services Management (WSMAN) protocol, then the WSMAN protocol is used to install a location agnostic client 460, such as an Open Mobile Alliance Device Management (OMA DM) client, onto electronic device B, if another electronic device C's device capabilities indicate that electronic device C uses Technical Requirement-069 (TR-069) protocol, then the TR-069 protocol is used to install a location agnostic client 460, such as OMA DM client, onto electronic device C. The location agnostic clients that are installed on the electronic devices B and C can be used to communicate with location agnostic server, such as location agnostic server 440, to provide management to both of the electronic devices B and C.

Different electronic devices B and C have different capabilities. Information describing an electronic device B, C's capabilities can be used to determine the protocol that an electronic device B, C is configured to use. For example, information describing a device B, C's capabilities can be used to determine that the electronic device B or C has the ability to communicate using WSMAN or TR-069, for example.

The device capabilities may be requested or provided without being requested. For example, when an electronic device B, C is turned on, it performs a process called “boot strapping” during which the electronic device B, C is provisioned. While boot strapping, the electronic device B, C may communicate with a server 400A that can either request the electronic device B or C's capabilities or the electronic device B, C may provide its capabilities without the server 400A requesting the capabilities.

According to one embodiment, registration information for an electronic device B, C can be used by a server 400A to determine the management protocol that an electronic device B, C is configured to use. The registration information may be provided to any entity that provides an apparatus for managing electronic devices with different types of location limited clients, according to various embodiments in a specific example, the registration information may be provided by a company that sells electronic devices to, for example, a company that is a traditional IT enterprise that a management server is associated with.

According to one embodiment, information describing device capabilities can be determined based on management policies that reside for example with a management server, a service provider, the electronic device B, C in question, or at another electronic device associated with the same environment, such as a home or business premises, that the electronic device B, C in question is associated with.

According to one embodiment, information describing device capabilities can be used for reinstalling a management client, such as a location limited client or a location agnostic client, for example, if a managed dent is corrupted or disappears.

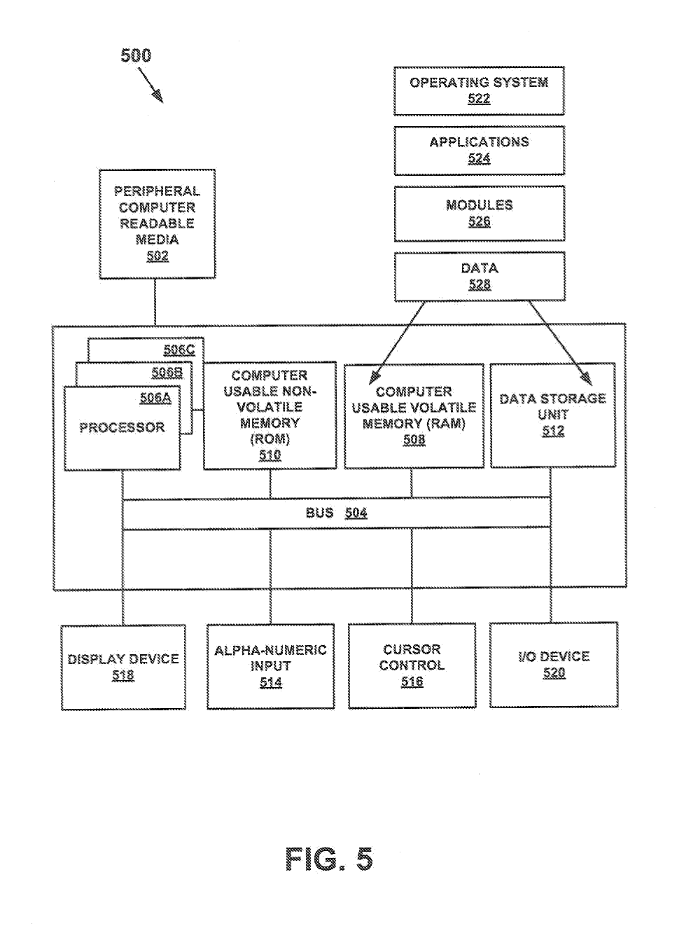

FIG. 5 depicts a block diagram of one example of a type of computer (computer system 500) that can be used in accordance with or to implement various embodiments which are discussed herein, it is appreciated that computer system 500 of FIG. 5 is only an example and that embodiments as described herein can operate on or within a number of different computer systems including, but not limited to, general purpose networked computer systems, embedded computer systems, routers, switches, server devices, client devices, various intermediate devices/nodes, stand alone computer systems, media centers, handheld computer systems, multi-media devices, and the like. As shown in FIG. 5, computer system 500 of FIG. 5 is well adapted to having peripheral computer-readable media 502 such as, for example, a floppy disk, a compact disc, and the like coupled thereto.

System 500 of FIG. 5 includes an address/data bus 504 for communicating information, and a processor 506A coupled to bus 504 for processing information and instructions. As depicted in FIG. 5, system 500 is also we suited to a multi-processor environment in which a plurality of processors 506A, 506B, and 506C are present. Conversely, system 500 is also well suited to having a single processor such as, for example, processor 506A. Processors 506A, 506B, and 506C may be any of various types of microprocessors. System 500 also includes data storage features such as a computer usable volatile memory 508, e.g. random access memory (RAM), coupled to bus 504 for storing information and instructions for processors 506A, 506B, and 506C. System 500 also includes computer usable non-volatile memory 510, e.g. read only memory (ROM), coupled to bus 504 for storing static information and instructions for processors 506A, 506B, and 506C. Also present in system 500 is a data storage unit 512 (e.g., a magnetic or optical disk and disk drive) coupled to bus 504 for storing information and instructions. System 500 also includes an optional alphanumeric input device 514 including alphanumeric and function keys coupled to bus 504 for communicating information and command selections to processor 506A or processors 506A, 506B, and 506C. System 500 also includes an optional cursor control device 518 coupled to bus 504 for communicating user input information and command selections to processor 506A or processors 506A, 506B, and 506C. In one embodiment, system 500 also includes an optional display device 518 coupled to bus 504 for displaying information.

Referring still to FIG. 5, optional display device 518 of FIG. 5 may be a liquid crystal device, cathode ray tube, plasma display device or other display device suitable for creating graphic images and alphanumeric characters recognizable to a user. Optional cursor control device 516 allows the computer user to dynamically signal the movement of a visible symbol (cursor) on a display screen of display device 513 and indicate user selections of selectable items displayed on display device 518. Many implementations of cursor control device 516 are known in the art including a trackball, mouse, touch pad, joystick or special keys on alpha-numeric input device 514 capable of signaling movement of a given direction or manner of displacement. Alternatively, it will be appreciated that a cursor can be directed and/or activated via input from alpha-numeric input device 514 using special keys and key sequence commands. System 500 is also well suited to having a cursor directed by other means such as, for example, voice commands. System 500 also includes an I/O device 520 for coupling system 500 with external entities. For example, in one embodiment, I/O device 520 is a modem for enabling wired or wireless communications between system 500 and an external network such as, but not limited to, the Internet.

Referring still to FIG. 5, various other components are depicted for system 500. Specifically, when present, an operating system 522, applications 524, modules 526, and data 528 are shown as typically residing in one or some combination of computer usable volatile memory 508, (e.g., RAM), computer usable non-volatile memory 510 (e.g., ROM), and data storage unit 512. In some embodiments, altar portions of various embodiments described herein are stored, for example, as an application 524 and/or module 526 in memory locations within RAM 508, computer-readable media within data storage unit 512, peripheral, computer-readable media 502, and/or other tangible computer readable media.

For example, any one or more of 110, 120, 140, 150 (FIG. 1), instructions implementing the flowchart 200 (FIG. 2), 310, 320, 330, 340 (FIG. 3), 410, 420, 430, 440, 460, 470, 480, 490 (FIG. 4) may be associated with a computer 500. Any one or more of 110, 120, 140, 150 (FIG. 1), instructions implementing the flowchart 200 (FIG. 2), 310, 320, 330, 340 (FIG. 3), 410, 420, 430, 440, 460, 470, 480, 490 (FIG. 4) may be associated with the same computer 500 or with different computers 500. According to one embodiment, the converged electronic device 110 (FIG. 1), the server device 400A, and the electronic device 400B are computers 500. Any one or more of 110, 120, 140, 150 (FIG. 1), instructions implementing the flowchart 200 (FIG. 2), 310, 320, 330, 340 (FIG. 3), 410, 420, 430, 440, 460, 470, 480, 490 (FIG. 4) may be associated with a computer 500 in the form of hardware, software, firmware, or a combination thereof. In the case of software, any one or more of 110, 120, 140, 150 (FIG. 1), instructions implementing the flowchart 200 (FIG. 2), 310, 320, 330 (FIG. 3), 410, 420, 440, 460, 470, 490 (FIG. 4) may be associated with the applications 524 or the peripheral computer-readable media 502, among other things. Any one or more of any one or more of 110, 120, 140, 150 (FIG. 1), instructions implementing the flowchart 200 (FIG. 2), 310, 320, 330 (FIG. 3), 410, 420, 440, 460, 470, 490 (FIG. 4) may be associated with applications 524 for the same computer 500 or for different computers 500. Any one or more of any one or more of 110, 120, 140, 150 (FIG. 1), instructions implementing the flowchart 200 (FIG. 2), 310, 320, 330 (FIG. 3), 410, 420, 440, 460, 470, 490 (FIG. 4) may be associated with the same computer-readable media 502 or different computer-readable media 502. According to one embodiment, 310, 320, 30 (FIG. 1) are on separate computer-readable media 502 and are installed on one or more computers 500 as described herein. According, to one embodiment, 410, 420, 440, 460, 470, 490 (FIG. 4) are on separate computer-readable media 502 that are used to install 410, 420, 440, 460, 470, 490 (FIG. 4) onto the server device 400A and the electronic device 400B as depicted in FIG. 4. The mappings 340 (FIG. 3), 430, 480 (FIG. 4) may be stored as data 528, among other things, that is used by the same computer 500 or different computers 500

Various embodiments have been described in various combinations. However, any two or more embodiments may be combined. Further, any embodiment may be used separately from any other embodiments.

The foregoing description, for purposes of explanation, has been described with reference to specific embodiments. However the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A method of managing a converged electronic device that is capable of communicating with a plurality of connections, the method comprising:
using 220 a first configuration associated with the converged electronic device 110 while the converged electronic device 110 communicates using a first connection 132;
detecting 230 an event that relates to the converged electronic device 110 that indicates a second connection 134 could provide a higher level of service for the converged electronic device 110;
determining 240 a second configuration that would be used for the converged electronic device 110 while the converged electronic device 110 communicates using the second connection 134; and
using 250 the second configuration while the converged electronic device 110 communicates using the second connection 134.

2. The method as recited in claim 1, wherein the detecting 230 of the event further comprises:
receiving information indicating that user of the converged electronic device 110 determined that the second connection 134 provides the higher level of service for the converged electronic device 110.

3. The method as recited in claim 1, wherein the method further comprises:
obtaining the first configuration from a management server 150.

4. The method as recited in claim 1, wherein the method further comprises:
a service provider 140 providing the service to the converged electronic device 110 based on the first configuration; and
the service provider 140 adjusting the service provided to the converged electronic device 110 based on the second configuration.

5. An apparatus for of managing a converged electronic device that is capable of communicating with a plurality of connections, the apparatus comprising:
managing-a-converged-electronic-device-using-configurations-to-adjust-service-delivery-event-detector 122 configured for detecting an event that relates to the converged electronic device 110 that indicates a connection 132 could provide a higher level of service than what is currently being provided;
managing-a-converged-electronic-device-using-configurations-to-adjust-service-delivery-configuration-determiner 124 configured for determining which configuration would be used for the converged electronic device 110 while the converged electronic device 110 communicates using the connection 132; and
managing-a-coriverged-electronic-device-using-configurations-to-adjust-service-delivery-configuration-communicator 126 configured for communicating the determined configuration 134 to a service provider 140 to provide the level of service that the connection 132 is capable of.

6. The apparatus of claim 5, wherein the connection 132 is elect from group consisting of a network and a bearer.

7. The apparatus of claim 5, wherein the determined configuration includes information pertaining to one or more of device capabilities associated with the converged electronic device 110, quality of service (QoS), and bandwidth provided by the connection 132.

8. The apparatus of claim 5, wherein the apparatus further comprises a managing-a-converged-electronic-device-using-configurations-to-adjust-service-delivery-level-of-service-information-receiver configured for receiving information indicating that a user of the converged electronic device 110 determined that the connection provides the higher level of service for the converged electronic device 110.

9. The apparatus of claim 5, wherein the apparatus further comprises a managing-a-converged-electronic-device-using-configurations-to-adjust-service-delivery-configuration-receiver configured for obtaining configurations from a management server 150.

10. The apparatus of claim 5, wherein a user of the converged electronic device 110 determines whether the connection 132 provides the higher level of service.

11. A computer-usable medium having computer-readable program code stored thereon for causing a computer system to perform a method of managing a converged electronic device that is capable of communicating with a plurality of connections, the method comprising:
using 220 a first configuration associated with the converged electronic device 110 while the converged electronic device 110 communicates using a first connection 132;
detecting 230 an event that relates to the con verged electronic device 110 that indicates a second connection 134 could provide a higher level of service for the converged electronic device 110;
determining 240 a second configuration that would be used for the converged electronic device 110 while the converged electronic device 110 communicates using the second connection 134; and
using 250 the second configuration while the converged electronic device 110 communicates using the second connection 134.

12. The computer readable medium of claim 11, wherein the computer-readable program code embodied therein causes a computer system to perform the method, and wherein the detecting 230 of the event further comprises:
receiving information indicating that a user of the converged electronic device 110 determined that the second connection 134 provides the higher level of service for the converged electronic device 110.

13. The computer readable medium of claim 11, wherein the computer-readable program code embodied therein causes a computer system to perform the method, and wherein the method further comprises:
obtaining the first configuration from a management server 150.

14. The computer readable medium of claim 11, wherein the computer-readable program code embodied therein causes a computer system to perform the method, and wherein the method further comprises:
a service provider 140 providing the service to the converged electronic device 110 based on the first configuration; and
the service provider 140 adjusting the service provided to the converged electronic device 110 based on the second configuration.

15. The computer readable medium of claim 11, wherein the computer-readable program code embodied therein causes a computer system to perform the method, and wherein the first connection 132 and the second connection 134 are selected from a group consisting of a network and a bearer.
